(19) United States
(12) Patent Application Publication
(10) Pub. No.: US 2025/0210629 A1
(43) Pub. Date: Jun. 26, 2025

(54) COMPOSITE CATHODE MATERIAL, PREPARATION METHOD THEREOF, AND APPLICATION THEREOF

(71) Applicant: SHENZHEN DYNANONIC CO., LTD., Shenzhen, Guangdong (CN)

(72) Inventors: Rongyi XU, Shenzhen, Guangdong (CN); Yi YANG, Shenzhen, Guangdong (CN); Lingyong KONG, Shenzhen, Guangdong (CN); Yineng LI, Shenzhen, Guangdong (CN); Qifeng LIU, Shenzhen, Guangdong (CN)

(73) Assignee: SHENZHEN DYNANONIC CO., LTD., Shenzhen, Guangdong (CN)

(21) Appl. No.: 18/848,299

(22) PCT Filed: Sep. 6, 2022
(86) PCT No.: PCT/CN2022/117376

§ 371 Date: Sep. 18, 2024

(30) Foreign Application Priority Data
Mar. 28, 2022 (CN) 202210314912.0

(51) Int. Cl. H01M 4/36; H01M 4/02; H01M 4/04; H01M 4/136; H01M 4/1397; H01M 4/58; H01M 4/62

(52) U.S. Cl. CPC H01M 4/366; H01M 4/0471; H01M 4/136; H01M 4/1397; H01M 4/5825; H01M 4/625; H01M 2004/021; H01M 2004/028

(57) ABSTRACT

A composite cathode material, a preparation method thereof, and an application thereof are provided. The composite cathode material of the present application includes: a conductive core, and a cathode material coating layer covering the conductive core. The composite cathode material further includes a conductive skeleton. One end of the conductive skeleton is in contact with the conductive core, and an other end of the conductive skeleton at least extends into the cathode material coating layer. The composite cathode material of the present application has high conductivity, structural stability, and compaction density, and has high cycle performance and electrochemical performance. The preparation method of the composite cathode material can ensure that the structure and electrochemical performance of the prepared composite cathode material are stable, and the efficiency is high, thus saving production costs.

### CROSS-REFERENCE TO RELATED APPLICATIONS

This application is the U.S. national phase of International Application No. PCT/CN2022/117376 with an international filing date of Sep. 6, 2022, designating the U.S., now pending, and claims the benefit of the Chinese patent application filed with the China Patent Office on Mar. 28, 2022, with an application number 202210314912.0 and titled “COMPOSITE CATHODE MATERIAL, PREPARATION METHOD THEREOF, AND APPLICATION THEREOF”, the entire contents of which are incorporated by reference in the present application.

### TECHNICAL FIELD

The present application relates to the technical field of secondary batteries, more particularly to a composite cathode material, a preparation method thereof, and an application thereof.

### BACKGROUND

The oil energy crisis in the 1960s and 1970s forced people to look for new alternative new energy sources. As people's awareness of environmental protection and energy crisis increases, the lithium-ion battery is considered to be one of the most promising energy sources due to the advantages of high operating voltage and energy density, relatively small self-discharge level, no memory effect, no heavy metal pollution such as lead and cadmium, ultra-long cycle life, and the like. The lithium-ion battery is widely used in electric vehicles, power tools, portable electronic consumer products, energy storage, and many other aspects.

A cathode material, an anode material, and an electrolyte are the key factors that determine the electrochemical performance of a lithium-ion battery. The cathode material plays the role of a lithium source in the lithium-ion battery, and is one of the important components of the lithium-ion battery, as well as a key factor that restricts the electrochemical performance, such as a specific energy and a specific power, of the lithium-ion battery. At present, a commonly used cathode material for the lithium-ion battery mainly includes: a layered cathode material, including lithium cobalt oxide (LiCoO₂), lithium nickel oxide (LiNiO₂), lithium manganate (LiMnO₂), and a binary/ternary composite layered cathode material (LiNiₓCo_{y}Mn_{z}O₂); a spinel lithium manganate (LiMn₂O₂); an olivine-type lithium iron phosphate (LiFePO₄), lithium manganese iron phosphate (LiMnₓFe₁₋ₓPO₄), and the like.

Although having many advantages, the lithium-ion battery material still faces many problems that need to be solved during the application, such as poor material conductivity, low compaction density, severe capacity attenuation under high current, poor rate performance, and the like. Moreover, the preparation method for the lithium-ion battery material also has problems of expensive raw materials, high production cost, difficulty in realizing the industrial production, and the like.

### SUMMARY

It is an objective of the present application to overcome the above-mentioned defects of the prior art, and to provide a composite cathode material and a preparation method thereof, so as to solve the technical problems of poor conductivity and low compaction density of the existing cathode materials.

It is another objective of the present application to provide a cathode plate and a secondary battery comprising the cathode plate, so as to solve the technical problems of poor electrochemical performance, such as serious capacity attenuation and poor rate performance of the secondary battery caused by the existing cathode materials.

In order to achieve the above objectives, in a first aspect of the present application, a composite cathode material is provided. The composite cathode material of the present application comprises: a conductive core, and a cathode material coating layer covering the conductive core. The composite cathode material further comprises a conductive skeleton. One end of the conductive skeleton is in contact with the conductive core, and an other end of the conductive skeleton at least extends into the cathode material coating layer.

In a second aspect of the present application, a preparation method for preparing a composite cathode material is provided. The preparation method for preparing the composite cathode material comprises the following steps:
preparing a composite particle formed by a conductive skeleton and a conductive particle; in which, one end of the conductive skeleton is bonded to the conductive particle, and an other end of the conductive skeleton away from the conductive particle forms a free extension end; and
forming a cathode material coating layer covering the composite particle at a surface of the composite particle, in which, the free extension end of the conductive skeleton at least extends into the cathode material coating layer to form the composite cathode material.

In a third aspect of the present application, a cathode plate is provided. The cathode plate comprises: a current collector and a cathode active layer bonded to a surface of the current collector. The cathode active layer comprises the composite cathode material according to embodiments of the present application or the composite cathode material prepared by the preparation method according to embodiments of the present application.

In a fourth aspect of the present application, a secondary battery is provided. The secondary battery of the present application comprises a cathode plate and an anode plate. The cathode plate is the cathode plate according to embodiments of the present application.

Compared with the prior art, advantages of the present application are summarized as follows:

In the composite cathode material of the present application, a conductive skeleton is added between the conductive core and the cathode material coating layer, and the conductive skeleton extends into the cathode material coating layer, in this way, the conductive skeleton enhances the conductivity of the cathode material coating layer. In addition, due to the connection with the conductive core, the conductive skeleton, together with the conductive core, constructs a good conductive network structure in the composite cathode material, which making the composite cathode material have excellent conductivity. Moreover, the conductive skeleton can constitute channels for electrolyte penetration, which enables the electrolyte to penetrate into the composite cathode material through the conductive skeleton, such that the ion conduction distance inside the composite cathode material is effectively shortened, the compaction density and electrochemical performance of the composite cathode material are significantly improved, and the electrical performance of the composite cathode material can be fully realized. Finally, since one end of the conductive skeleton is connected to the conductive core and the other end of the conductive skeleton extends into the cathode material coating layer, the mechanical strength of the cathode material coating layer to cover the conductive core is effectively enhanced, and the structural stability of the composite cathode material is enhanced, which enables the composite cathode material to have excellent electrochemical stability.

The preparation method of the composite cathode material of the present application can prepare the composite cathode material of the present application having a core-shell structure as described in the above, and enables the prepared composite cathode material to have the excellent conductivity, electrochemical performance, and structural stability as described in the above. In addition, the preparation method of the composite cathode material can ensure that the structure and electrochemical performance of the prepared composite cathode material are stable, and the efficiency is high, thus saving production costs.

Since the cathode plate of the present application includes the composite cathode material of the present application, the cathode plate of the present application has high capacity, good rate performance, and cycle performance.

Since the secondary battery of the present application includes the cathode plate of the present application, the secondary battery of the present application has high capacity, rate performance, and cycle performance, long service life, and stable electrochemical performance.

### BRIEF DESCRIPTION OF THE DRAWINGS

In order to more clearly illustrate the specific implementation of the present application or the technical solution in the prior art, the drawings required to be used in the specific implementation or prior art description will be briefly introduced below. Obviously, the drawings in the following description are some implementations of the present application. For those skilled in the art, other drawings can also be obtained based on these drawings without creative work.

FIG. 1 is a structural schematic diagram of a composite cathode material according to an embodiment of the present application;

FIG. 2 is another structural schematic diagram of a composite cathode material according to an embodiment of the present application; and

FIG. 3 is a schematic flowchart of a preparation method of a composite cathode material according to an embodiment of the present application.

### DETAILED DESCRIPTION OF THE EMBODIMENTS

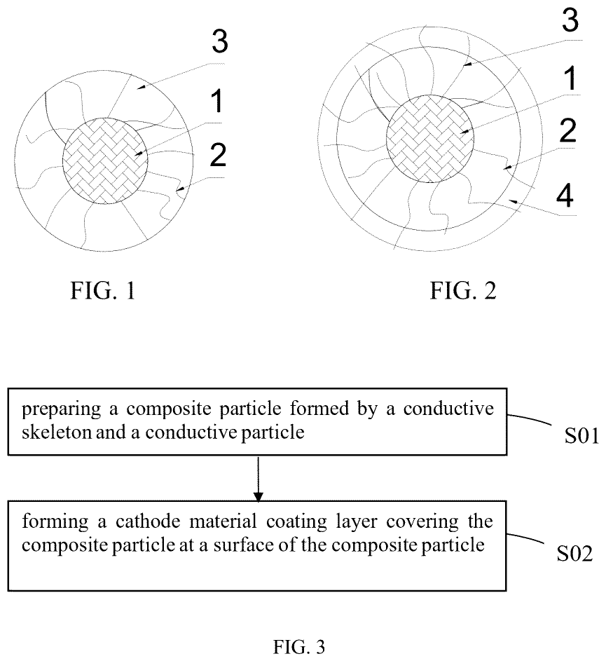

In a first aspect, embodiments of the present application provide a composite cathode material. The structure of the composite cathode material according to an embodiment of the present application is shown in FIG. 1, and comprises: a conductive core 1, a cathode material coating layer 3 covering the conductive core 1, and a conductive skeleton 2. One end of the conductive skeleton 2 is in contact with the conductive core 1, and an other end of the conductive skeleton 2 at least extends into the cathode material coating layer 3.

The conductive core 1 and the conductive skeleton 2 together form a conductive network system of the composite cathode material of embodiments of the present application, which enables the composite cathode material in the embodiments of the present application to have excellent conductivity and high rate performance.

In addition, the particle size of the conductive core 1 is also one of the factors affecting the particle size of the composite cathode material of the present application. Therefore, in an embodiment of the present application, the particle size of the conductive core 1 can be controlled to 80 nm, such as smaller than or equal to 80 nm. In a specific embodiment, a material of the conductive core comprises at least one of a carbon and a cathode material. The carbon may comprise a sintered carbon. The cathode material may be a cathode material having at least one property of low conductivity, high specific surface area, and low compaction density, specifically, the cathode material may be at least one of lithium iron phosphate (LFP), lithium manganate, and lithium manganese phosphate. By controlling and selecting the particle size and material type of the conductive core 1, the above functions of the conductive core 1 can be improved, thereby improving the conductivity, rate performance, and capacity of the composite cathode material in embodiments of the present application. In addition, by controlling and adjusting the particle size of the conductive core 1, in combination with the thickness of the cathode material coating layer 3, the particle size of the composite cathode material can be controlled and adjusted, for example, the particle size of the composite cathode material is increased, thereby improving the compaction density of the composite cathode material in embodiments of the present application.

The conductive skeleton 2 not only forms a conductive network system with the conductive core 1 in the composite cathode material in embodiments of the present application, but also can form channels for electrolyte penetration, which enables the electrolyte to penetrate into the composite cathode material through the conductive skeleton 2, such that the ion conduction distance inside the composite cathode material is effectively shortened, the compaction density and electrochemical performance of the composite cathode material are significantly improved, and the electrical performance of the composite cathode material can be fully realized. In addition, since one end of the conductive skeleton 3 is connected to the conductive core 1 and the other end of the conductive skeleton 3 extends into the cathode material coating layer 3, the mechanical strength of the cathode material coating layer 3 to cover the conductive core 1 is effectively enhanced, and the structural stability of the composite cathode material is enhanced, which enables the composite cathode material to have excellent electrochemical stability.

In an embodiment, a mass ratio of the conductive skeleton 2 to the conductive core 1 may be controlled to be (1 to 3): 1. By controlling the content of the conductive skeleton 2, such as controlling the mass ratio of the conductive skeleton 2 to the conductive core 1, an abundant conductive network structure is constructed in the composite cathode material on the basis of ensuring the capacity of the composite cathode material, that is, abundant conductive channels are formed in the composite cathode material, thereby significantly improving the conductivity of the composite cathode material, enhancing the compaction density and electrochemical performance of the composite cathode material, and improving the structural stability thereof.

In other embodiments, a length of the conductive skeleton 2 may be 6 μm to 8 μm, and specifically, when the conductive skeleton is a carbon nanotube, a carbon fiber, and the like, a length thereof may be 6 μm to 8 μm. When the conductive skeleton adopts a structure of a hollow tube, such as a carbon nanotube, an inner diameter of the hollow tube may be 2 nm to 20 nm. When the conductive skeleton is a graphite flake, a conductive graphite, or graphene, a length or a width or a particle size thereof may be 6 μm to 8 μm. When the conductive skeleton is a graphite flake or graphene, a thickness thereof may be 2 nm to 40 nm. A dimension of the conductive skeleton 2, such as a length thereof, may at least extend into the cathode material coating layer 3, that is, the free end of the conductive skeleton 2 extending outward from the conductive core 1 at least extends into the cathode material coating layer 3. For example, the free end extending outward from the conductive core 1 can extend into the cathode material coating layer 3, also, after extending into the cathode material coating layer 3, the free end may be bent or further form a network structure or a winding contact with other conductive skeletons 2, and the like, or alternatively, the free end may pass through the cathode material coating layer 3 and extend to an outer surface of the cathode material coating layer 3. The outer surface of the cathode material coating layer 3 refers to a surface of the cathode material coating layer 3 away from the conductive core 1. By controlling and optimizing the diameter and the length of the conductive skeleton 2, the conductive skeleton 2 can be fully realized to play the role of the conductive channels as mentioned in above and to improve the role of the reinforcing ribs, and further enhance the compaction density, electrochemical performance, and structural stability of the composite cathode material.

In an embodiment, the conductive skeleton 2 may a hollow tube structure. In this way, the conductive liquid can efficiently enter the interior of the composite cathode material through the structure of the hollow tube. In a specific embodiment, a material of the conductive skeleton 2 may comprise at least one of a carbon nanotube, a graphite flake, a conductive graphite, a carbon fiber, and graphene. By selecting the material of the conductive skeleton 2, the conductivity of the conductive skeleton 2 is improved and the role of the mechanical reinforcing ribs is enhanced, and the compaction density, electrochemical performance, and structural stability of the composite cathode material are further improved. Due that the carbon nanotube is a hollow microtube structure, which is a special structure itself, when the material of the conductive skeleton 2 is the carbon nanotube, the carbon nanotube is distributed in the cathode material coating layer 3 as the conductive skeleton, making the composite cathode material, specifically the cathode material coating layer 3 contained therein, present abundant channels. The channels enable the electrolyte (conductive liquid) to directly penetrate into the interior of the composite cathode material through the channels, thereby effectively overcoming the disadvantage of poor electrical performance of cathode material, such as lithium manganese iron phosphate particle, due to excessively long conduction distance. Meanwhile, since the distance from the inside of the composite cathode material particle to contact the conductive liquid is shortened, the conduction distance of the particle is shortened, and the electrical performance is fully released.

The cathode material coating layer 3 plays the role of a cathode material in the composite cathode material. Moreover, the cathode material coating layer 3 plays a synergistic role between the conductive core 1 and the conductive skeleton 2, as well as within the three, making the composite cathode material have high conductivity, structural stability, and compaction density, as well as making the composite cathode material have excellent cycle performance and high electrochemical performance.

In an embodiment, a mass ratio of the cathode material coating layer 3 to the conductive core 1 may be controlled to be (100 to 300): 1. By controlling the content of the cathode material coating layer, such as controlling a mass ratio of the cathode material coating layer to the conductive core 1, on the basis of improving the capacity of the composite cathode material, the synergistic effect between the conductive core 1 and the conductive skeleton 2 is improved, and the conductivity, compaction density, electrochemical performance, and structural stability of the composite cathode material are further improved.

In an embodiment, a thickness of the cathode material coating layer 3 can be 3 μm to 6 μm. In a specific embodiment, a cathode material contained in the cathode material coating layer 3 comprises at least one of a phosphate-based cathode material and lithium manganate. The phosphate-based cathode material can comprise at least one of lithium manganese iron phosphate, lithium iron phosphate, and lithium manganese phosphate. By controlling and optimizing the thickness and material of the conductive coating layer 3, the function of the cathode material in the composite cathode material can be fully realized.

Based on the mass ratio of the conductive core 1, the conductive skeleton 2, and the cathode material coating layer 3, in an embodiment, the mass ratio of the conductive core 1, the conductive skeleton 2, and the cathode material coating layer 3 may be 1:(1 to 3):(100 to 300). By coordinating the mass ratio of the three, a synergistic role among the three components are fully realized on the basis of the three components fully playing their respective roles, thereby improving the conductivity, structural stability, and compaction density of the composite cathode material, making the composite cathode material excellent cycle performance and high electrochemical performance.

The composite cathode material in embodiments of the present application has the core-shell structure as described in the above, as well as contains a conductive skeleton 2, thus, on the basis of achieving the synergistic effect of the three components and improving the conductivity and structural stability of the composite cathode material to improve the electrochemical performance of the composite cathode material in embodiments of the present application, it is also possible to adjust the mass ratio of the conductive core 1 to the cathode material coating layer 3, to appropriately enlarge the particle size of the composite cathode material, which can further improve the compaction density of the composite cathode material, and reduce the preparation costs. In an embodiment, a D50 of the composite cathode material may be controlled at 3 μm to 6 μm.

Based on the materials selected for the conductive core 1, the conductive skeleton 2, and the cathode material coating layer 3 contained in the composite cathode material according to the above embodiments of the present application, for example, the conductive core 1 contained in the composite cathode material is a sintered carbon, the conductive skeleton 2 is a carbon nanotube, and the cathode material is lithium manganese iron phosphate. In this way, the composite cathode material is a lithium manganese iron phosphate cathode material with a core-shell structure, and the lithium manganese iron phosphate cathode material also has an abundant channel structure. The lithium manganese iron phosphate cathode material in such a structure not only has excellent electrical conductivity and structural stability, but also allow the conductive liquid to penetrate into the lithium manganese iron phosphate cathode material particle through the carbon nanotube, which tackles the disadvantage of poor electrical performance caused by the long conduction distance in the existing lithium manganese iron phosphate particle. Due to the characteristic that the distance for the inside of the lithium manganese iron phosphate cathode material particle to contact the conductive liquid is shortened, the conduction distance of the particle becomes shorter, the electrical property is perfectly and fully released, and the electrochemical performance of the lithium manganese iron phosphate cathode material is greatly improved. Therefore, the particle size of the lithium manganese iron phosphate cathode material particle can be appropriately enlarged to produce certain small agglomerations, thereby improving the processing performance and the cycle performance of the material, and effectively improving the compaction density of the lithium manganese iron phosphate cathode material.

In a further embodiment, on the basis of the above embodiments, the composite cathode material in this embodiment of the present application further comprises a conductive coating layer 4, as shown in FIG. 2. The conductive coating layer 4 is coated on an outer surface of the cathode material coating layer 3, which can further enhance the conductivity of the composite cathode material, and further can realize the conductive connection between the conductive core 1 and the conductive coating layer 4 through the conductive skeleton 2, thereby significantly improving the rate performance of the composite cathode material. For example, in an embodiment, an extended end of the conductive skeleton 2 extends into the conductive coating layer 4 or further extends to an outer surface of the conductive coating layer 4 to make the extended end exposed. As shown in FIG. 2, the extended end of the conductive skeleton 2 at least partially extends to the outer surface of the conductive coating layer 4 to improve the inward penetration efficiency of the electrolyte. Furthermore, by controlling the thickness of the conductive coating layer 4, in combination with the particle size of the conductive core 1 and the thickness of the cathode material coating layer 3, a composite cathode material with a large particle size can be further obtained, thereby improving the compaction and density of the composite cathode material.

In an embodiment, a thickness of the conductive coating layer 4 is 2 nm to 20 nm; in a specific embodiment, the conductive material contained in the conductive coating layer 4 comprises a carbon material, such as at least one of a graphite, a carbon black, and/or an acetylene black. By controlling and optimizing the thickness and the material of the conductive coating layer 4, the conductive effect of the conductive coating layer 4 is further realized, and the conductivity, the rate performance, and the compaction density of the composite cathode material are improved.

In a second aspect, embodiments of the present application also provide a preparation method of the above composite cathode material. The preparation method of the composite cathode material in embodiments of the present application comprises the following steps:

S01: preparing a composite particle formed by a conductive skeleton and a conductive particle; wherein one end of the conductive skeleton is bonded to the conductive particle, and an other end of the conductive skeleton away from the conductive particle forms a free extension end; and

S02: forming a cathode material coating layer covering the composite particle at a surface of the composite particle, wherein the free extension end of the conductive skeleton at least extends into the cathode material coating layer to form the composite cathode material.

In the above embodiments, the conductive particle in step S01 is the conductive core 1 contained in the composite cathode material as described in the above, and the conductive skeleton in step S01 is the conductive skeleton 2 contained in the composite cathode material as described in the above. The cathode material coating layer in step S02 is the cathode material coating layer 3 contained in the composite cathode material as described in the above. Therefore, in order to save space, the conductive particle and the conductive skeleton in step S01 and the dimension of the material of the cathode material coating layer in step S02 will not be repeated hereinbelow.

In an embodiment, the method for preparing the composite particle formed by the conductive skeleton and the conductive particle in step S01 may comprise the following steps:

S011: providing the conductive particle, performing modification treatment by a first functional group on the conductive particle to obtain a modified conductive particle;

S012: providing the conductive skeleton, performing modification treatment by a second functional group on one end of the conductive skeleton to obtain a modified conductive skeleton; in which, the second functional group is a functional group capable of chemically reacting with the first functional group to form a chemical bond; and

S013: subjecting the modified conductive particle and the modified conductive skeleton to a first mixing treatment and a chemical reaction treatment, so that a modified end of the conductive skeleton is bonded to the conductive particle to obtain the composite particle.

The modification treatment by the first functional group on the conductive particle in step S011 is to graft a functional group on the conductive particle, which allows the modified conductive particle to chemically react in step S013 with the modified conductive skeleton obtained in step S012, so that the modified end of the conductive skeleton can be bonded to the conductive particle. Therefore, in an embodiment, the first functional group may comprise at least one of a hydroxyl, an aldehyde group, a carboxyl, an amino, an ester group, and an anhydride. Then the method of modifying the conductive particle by the first functional group can also be flexibly selected and controlled according to the type of the first functional group. When the conductive particle is a carbon material, such as, a sintered carbon, the conductive particle can be formed by carbonization treatment of at least one of sucrose, glucose, oxalic acid, salicylic acid, citric acid, tartaric acid, malic acid, glycine, ethylene diamine tetraacetic acid, and succinic acid.

Based on the modification treatment on the conductive particle by the first functional group in step S011, the modification treatment on the conductive skeleton by the second functional group in step S012 is also to graft the corresponding functional group on one end of the conductive skeleton, to enable the modified conductive skeleton to chemically react in step S013 with the modified conductive particle obtained in step S011, so that the modified end of the modified conductive skeleton can be bonded to the conductive particle. Therefore, in an embodiment, the second functional group can be the same or different from the above-mentioned first functional group, as long as that the first functional group and the second functional group can chemically react. Therefore, the second functional group can comprise at least one of a hydroxyl, an aldehyde group, a carboxyl, an amino, an ester group, and an anhydride. In a specific embodiment, the combination of the first functional group and the second functional group can be a combination of the hydroxyl and the aldehyde group, a combination of the carboxyl and the amino, a combination of the aldehyde group and the aldehyde group, a combination of the ester group and the ester group, a combination of the aldehyde group and the anhydride, and the like. The method of modifying the conductive skeleton by the second functional group can also be flexibly selected and controlled according to the type of the second functional group.

In step S013, the conditions for the chemical reaction between the modified conductive particle and the modified conductive skeleton may be controlled according to the reaction conditions for the types of the functional groups contained therein, so that the first functional group and the second functional group react to form a chemical bond, so that the modified end of the conductive skeleton can be bonded to the conductive particle, and the other end of the conductive skeleton forms a free extension end.

In an embodiment, the modified conductive particle and the modified conductive skeleton may be first mixed according to a mass ratio of the conductive particle to the conductive skeleton being 1: (1 to 3), so that the mass ratio of a resulting conductive particle and a resulting conductive skeleton satisfies the mass ratio of the conductive particle 1 to the conductive skeleton 2 contained in the composite cathode material as described in the above.

In an embodiment, the method of forming the cathode material coating layer covering the composite particle at the surface of the composite particle in step S01, comprises the following steps:

S014: subjecting a cathode material or a cathode material precursor to a second mixing treatment with the composite particle, to enable the cathode material or the cathode material precursor to cover the surface of the composite particle, then performing sintering treatment;

During the sintering treatment in step S014, the cathode material or the cathode material precursor is sintered to form the cathode material coating layer. Therefore, the cathode material is the cathode material of the cathode material coating layer 3 contained in the composite cathode material in the above. Similarly, the cathode material precursor is a precursor for forming the cathode material of the cathode material coating layer 3 contained in the composite cathode material in the above. Then the sintering treatment conditions are conditions that can at least make the cathode material or the cathode material precursor sintered to form the cathode material coating layer. For example, in an embodiment, the sintering treatment can be performed at a temperature of 600° C. to 700° C. for a duration of 5 hrs to 8 hrs. It can be flexibly controlled according to the specific sintering characteristics of the cathode material or the cathode material precursor.

Since the other end of the conductive skeleton contained in the composite particle away from the conductive particle forms a free extension end, then in the second mixing treatment, the free extension end of the conductive skeleton will extend to the coating layer formed by the cathode material or the cathode material precursor, then after the sintering treatment, the free extension end of the conductive skeleton at least extends to the cathode material coating layer to form the composite cathode material shown in FIG. 1 in the above. In an embodiment, the second mixing treatment may be a ball milling treatment, or a mixing treatment such as stirring to form a slurry of the cathode material or the cathode material precursor with the composite particle, so that the cathode material or the cathode material precursor forms a coating layer on the surface of the composite particle.

In an embodiment, the cathode material or the cathode material precursor and the composite particle may be subjected to the second mixing treatment according to a mass ratio of the conductive skeleton to the cathode material being (1 to 3):(100 to 300), so that the mass ratio of the resulting cathode material coating layer to the resulting composite particle after the sintering treatment satisfies the mass ratio of the conductive particle 1 to the cathode material coating layer 3 contained in the composite cathode material as described in the above.

In a further embodiment, after the step of forming the cathode material coating layer covering the composite particle at the surface of the composite particle, the method further comprises the following step S03:
forming a conductive coating layer covering the cathode material coating layer at a surface of the cathode material coating layer.

The conductive coating layer formed in step S03 is the conductive coating layer 4 contained in the composite cathode material as described in the above, that is, the composite cathode material as shown in FIG. 2 is formed. Then the material and thickness of the conductive coating layer formed in step S03 are the same as the conductive coating layer 4 contained in the composite cathode material as described in the above.

In an embodiment, the method for forming the conductive coating layer can be carried out by solution coating of a conductive material or a precursor of a conductive material, followed by sintering treatment. Or alternatively, other methods for forming a coating layer can be used to form a conductive coating layer so as to cover the outer surface of the cathode material coating layer 3.

It can be seen from the preparation method of the composite cathode material in the above embodiments of the present application that the preparation method of the composite cathode material of the embodiments of present application can prepare the composite cathode material of the present application having a core-shell structure as described in the above, and enables the prepared composite cathode material to have the excellent conductivity, electrochemical performance, and structural stability as described in the above. In addition, the preparation method of the composite cathode material can ensure that the structure and electrochemical performance of the prepared composite cathode material are stable, and the efficiency is high, thus saving production costs. Since the composite cathode material in embodiments of the present application can have relatively large particle size, the preparation method of the composite cathode material in embodiments of the present application can reduce the control and requirements for the composite cathode material, thereby making the preparation method of the composite cathode material in embodiments of the present application highly efficient and saving production costs.

In addition, after the above step S02 or step S03, the method further comprises a step of crushing or granulating the material to control the particle size and uniformity of the final material.

In a third aspect, embodiments of the present application also provide a cathode plate. The cathode plate in the embodiments of the present application comprises a cathode current collector and a cathode active layer bonded to a surface of the cathode current collector. The cathode active layer contains the composite cathode material in embodiments of the present application. Since the cathode plate in the embodiments of the present application contains the composite cathode material in embodiments of the present application, the cathode plate has low internal resistance, high capacity, and good rate performance, and good cycle performance.

The cathode active layer comprises a binder and a conductive agent, in addition to the composite cathode material, in which, the binder can be a commonly used electrode binder, such as one or more of a polyvinylidene chloride, a soluble polytetrafluoroethylene, a polymerized styrene butadiene rubber, a hydroxypropyl methyl cellulose, methyl cellulose, a carboxymethyl cellulose, a polyvinyl alcohol, an acrylonitrile copolymer, a sodium alginate, a chitosan, and a chitosan derivative. In embodiments of the present application, the conductive agent may be a commonly used conductive agent, such as one or more of a graphite, a carbon black, an acetylene black, a graphene, a carbon fiber, a C60, and a carbon nanotube. Or alternatively, the cathode active layer may also contain a lithium-supplementing additive to improve the initial columbic efficiency of the battery.

In an embodiment, a preparation process for the cathode plate may be as follows: mixing the composite cathode material, the conductive agent, and the binder to obtain an electrode slurry, coating the electrode slurry on the electrode current collector, performing drying, rolling, die cutting, and other steps to obtain the cathode plate.

In a fourth aspect, embodiments of the present application also provide a secondary battery. The secondary battery in the embodiments of the present application comprises necessary components such as a cathode plate, an anode plate, a separator, and an electrolyte, and other necessary or auxiliary components. The cathode plate is the cathode plate according to the embodiments of the present application as described in the above.

Since the secondary battery in the embodiments of the present application comprises the cathode plate in the embodiments of the present application, and the cathode plate in the embodiments of the present application comprises the composite cathode material in the embodiments of the present application, based on the characteristics of the composite cathode material in the embodiments of the present application, the secondary battery in the embodiments of the present application has high capacity, rate performance, and cycle performance, long service life, and stable electrochemical performance.

A number of detailed examples are further described hereinbelow to further explain the composite cathode material, the preparation method thereof, and the application therefor in the embodiments of the present application.

### 1. Examples of Composite Cathode Material and Preparation Method Thereof

### Example 1

This example provides a composite cathode material and a preparation method thereof. The composite cathode material provided by this example is a lithium manganese iron phosphate cathode material in a single core-channel structure, specifically comprises: a carbon black particle, a carbon nanotube, and a lithium manganese iron phosphate coating layer covering the carbon black particle, and further comprises a carbon coating layer covering an outer surface of the lithium manganese iron phosphate coating layer. That is, the lithium manganese iron phosphate coating layer serves as an intermediate layer, and the carbon coating layer serves as an outer coating layer. One end of the carbon nanotube is bonded to a surface of the carbon black particle, and the other end of the carbon nanotube away from the carbon black particle forms a free extension end, and the free extension end at least extends to the lithium manganese iron phosphate coating layer. It is known from the test that a part of the free extension end is distributed in the lithium manganese iron phosphate coating layer, and another part of the free extension end is distributed in the carbon coating layer or/and a surface thereof. A mass ratio of carbon black particle, the carbon nanotube, and the lithium manganese iron phosphate coating is 1:1:100.

The composite cathode material of this example was prepared by the following steps:

In step S1, a composite particle formed by the carbon nanotube and the carbon black particle was prepared as follows:

In step S11, a modified carbon black particle was prepared by modifying 1 g of the carbon black with 0.01 g of an amino group;

In step S12, a modified carbon nanotube was prepared by modifying 1 g of a carbon nanotube with 0.01 g of a carboxyl at one end of the carbon nanotube; and

In step S13, condensation reaction between the modified carbon black particle and the modified carbon nanotube was performed by mixing the modified carbon nanotube and the modified carbon black particle and subjecting the two to an amidation reaction, to enable the modified end of the carbon nanotube to be connected to a surface of the carbon black through an amide bond;

In step S2, 100 g of lithium manganese iron phosphate was placed in a tubular furnace introduced with nitrogen, added with 1 g of glucose, then roasted at a temperature of 650° C. for 5 hrs.

In step S3, the lithium manganese iron phosphate after being processed in step S2 was prepared into a slurry by sand milling, and then spray dried to enable the lithium manganese iron phosphate to form a lithium manganese iron phosphate coating layer on a surface of the composite particle.

In step S4, the composite material in step S3 was placed in a tubular furnace introduced with nitrogen, added with 20 g of glucose, and roasted at a temperature of 750° C. for 5 hrs to form a carbon coating layer on an outer surface of the lithium manganese iron phosphate coating layer, whereby obtaining a composite cathode material.

In step S5, the composite cathode material obtained in step S4 was cooled, then, crushed and screened to obtain a composite cathode material having a uniform particle size.

### Example 2

This example provides a composite cathode material and a preparation method thereof. The structure of the composite cathode material is the same as that of the composite cathode material in Example 1, except that the mass ratios of the carbon black particle, the carbon nanotube, the lithium manganese iron phosphate coating layer, and the carbon coating layer are different, in which, the mass ratio of the carbon black particle, the carbon nanotube, and the lithium manganese iron phosphate coating layer is 1:2:200.

The composite cathode material of this example was prepared by the following steps:

In step S1, a composite particle formed by the conductive skeleton and the conductive particle was prepared as follows:

In step S11, a modified carbon black particle was prepared by modifying 1 g of the carbon black with 0.02 g of an aldehyde group;

In step S12, a modified carbon nanotube was prepared by modifying 2 g of a carbon nanotube with 0.02 g of an aldehyde group at one end of the carbon nanotube; and

In step S13, condensation reaction between the modified carbon black particle and the modified carbon nanotube was performed by mixing the modified carbon nanotube and the modified carbon black particle and subjecting the two to an addition reaction, to enable the modified end of the carbon nanotube to be connected to a surface of the carbon black through a chemical bond.

In step S2, 200 g of lithium manganese iron phosphate was placed in a tubular furnace introduced with nitrogen, added with 2 g of glucose, then roasted at a temperature of 650° C. for 5 hrs.

In step S3, the lithium manganese iron phosphate after being processed in step S2 was prepared into a slurry by sand milling, and then spray dried to enable the lithium manganese iron phosphate to form a lithium manganese iron phosphate coating layer on a surface of the composite particle.

In step S4, the composite material in step S3 was placed in a tubular furnace introduced with nitrogen, added with 40 g of glucose, and roasted at a temperature of 750° C. for 5 hrs to form a carbon coating layer on an outer surface of the lithium manganese iron phosphate coating layer, whereby obtaining a composite cathode material.

In step S5, the composite cathode material obtained in step S4 was cooled, then, crushed and screened to obtain a composite cathode material having a uniform particle size.

### Example 3

This example provides a composite cathode material and a preparation method thereof. The structure of the composite cathode material is the same as that of the composite cathode material in Example 1, except that the mass ratios of the carbon black particle, the carbon nanotube, the lithium manganese iron phosphate coating layer, and the carbon coating layer are different, in which, the mass ratio of the carbon black particle, the carbon nanotube, and the lithium manganese iron phosphate coating layer is 1:3:300.

The composite cathode material of this example was prepared by the following steps:

In step S1, a composite particle formed by the conductive skeleton and the conductive particle was prepared as follows:

In step S11, a modified carbon black was prepared by modifying 1 g of the carbon black with 0.03 g of an aldehyde group;

In step S12, a modified carbon nanotube was prepared by modifying 3 g of a carbon nanotube with 0.03 g of an anhydride at one end of the carbon nanotube; and

In step S13, condensation reaction between the modified carbon source and the modified carbon nanotube was performed by mixing the modified carbon nanotube and the modified carbon black particle and subjecting the two to a condensation reaction, to enable the modified end of the carbon nanotube to be connected to a surface of the carbon black particle through an amide bond.

In step S2, 300 g of lithium manganese iron phosphate was placed in a tubular furnace introduced with nitrogen, added with 3 g of glucose, then roasted at a temperature of 650° C. for 5 hrs.

In step S3, the lithium manganese iron phosphate after being processed in step S2 was prepared into a slurry by sand milling, and then spray dried to enable the lithium manganese iron phosphate to form a lithium manganese iron phosphate coating layer on a surface of the composite particle.

In step S4, the composite material in step S3 was placed in a tubular furnace introduced with nitrogen, added with 60 g of glucose, and roasted at a temperature of 750° C. for 5 hrs to form a carbon coating layer on an outer surface of the lithium manganese iron phosphate coating layer, whereby obtaining a composite cathode material.

In step S5, the composite cathode material obtained in step S4 was cooled, then, crushed and screened to obtain a composite cathode material having a uniform particle size.

### Example 4

This example provides a composite cathode material and a preparation method thereof. The structure of the composite cathode material is the same as that of the composite cathode material in Example 1, except that the carbon black particle is replaced by an LFP particle, and the lithium manganese iron phosphate coating layer is replaced by an LFP coating layer, in which, a mass ratio of the LFP particle, the carbon nanotube, and the lithium iron phosphate coating layer is 1:1:200, and it is known from the test that a part of the free extension end of the carbon nanotube is distributed in the LFP coating layer, and another part of the free extension end is distributed in the carbon coating layer or/and a surface thereof.

The composite cathode material of this example was prepared by the following steps:

In step S1, 1 g of LFP was introduced with nitrogen, and 0.1 g of glucose was added and roasted at a temperature of 650° C. for 5 hrs.

In step S2, the LFP after being processed in step S1 was cooled, then, crushed and screened to obtain an LFP particle having a uniform particle size.

In step S3, a composite particle formed by a carbon nanotube and an LFP particle was prepare by the following steps:

In step S31, 1 g of LFP was modified with 0.02 g of an amino;

In step S32, 1 g of an carbon nanotube was coated with 0.02 g of an carboxyl at one end of the carbon nanotube; and

In step S33, an amino-containing LFP and a carboxyl-containing carbon nanotube were ball-milled for 2 hrs to enable the modified end of the carbon nanotube to be directional coated on the surface of LFP, so as to fix the skeleton.

In step S4, 200 g of manganese iron phosphate was placed in a tubular furnace introduced with nitrogen, added with 2 g of glucose added, then roasted at a temperature of 650° C. for 5 hrs.

In step S5, the lithium manganese iron phosphate after being processed in step S4 was prepared into a slurry by sand milling, and then spray dried to enable the lithium manganese iron phosphate to form a lithium manganese iron phosphate coating layer on a surface of the composite particle.

In step S6, the composite material in step S5 was placed in a tubular furnace introduced with nitrogen, added with 20 g of glucose, and roasted at a temperature of 750° C. for 5 hrs to form a carbon coating layer on an outer surface of the lithium manganese iron phosphate coating layer, whereby obtaining a composite cathode material.

In step S7, the composite cathode material obtained in step S6 was cooled, then, crushed and screened to obtain a composite cathode material having a uniform particle size.

### Comparative Example 1

The lithium manganese iron phosphate cathode material in Example 1 is provided, that is, this cathode material does not contain carbon black particle or carbon nanotube, and is simply a lithium manganese iron phosphate cathode material.

### Comparative Example 2

This comparative example provides a single-core multi-shell structured lithium manganese iron phosphate and a preparation method thereof. The lithium manganese iron phosphate in this comparative example comprises: a LiMn_{0.7}Fe_{0.29}V_{0.01}PO₄ core, a carbon intermediate coating layer covering the LiMn_{0.7}Fe_{0.29}V_{0.01}PO₄ core, a LiMn_{0.5}Fe_{0.5}PO₄ intermediate coating layer covering the carbon intermediate coating layer, and an amorphous carbon outer coating layer covering the LiMn_{0.5}Fe_{0.5}PO₄ intermediate coating layer.

The preparation method of lithium manganese iron phosphate in this comparative example comprises the following steps:

In step S1, Mn(CH₃COO)₂·4H₂O, FeC₂O₄·2H₂O, NH₄H₂PO₄, LiOH·H₂O, and V₂O₅ were collected according to a stoichiometric ratio of 0.7:0.29:1:1:0.005, and then added with C₁₂H₂₂O₁₁ glucose accounting for 20 wt. % of the total mass of Mn(CH₃COO)₂·4H₂O, FeC₂O₄·2H₂O, NH₄H₂PO₄, LiOH H₂O, and V₂O₅, added with 1 g of citric acid as an antioxidant, added with an appropriate amount of deionized water as a grinding aid, then ball milled at a speed of 400 rpm for 10 hrs. A resulting ball milled product was dried in an oven at a temperature of 60° C., ground, and screened by a 200-mesh sieve to obtain a first solid mixture.

In step S2, the first solid mixture was placed in an alumina porcelain boat and compacted, then pre-sintered in a tubular furnace under an argon-hydrogen atmosphere. The pre-sintering was started from a room temperature and was heated to 300° C. at a rate of 3° C./min. After the pre-sintering time lasted for 5 hrs, a pre-sintered product containing a carbon coating layer was obtained.

In step S3, after the pre-sintered product was ground and screened, certain amounts of Mn(CH₃COO)₂·4H₂O, FeC₂O₄·2H₂O, LiOH H₂O, and NH₄H₂PO₄ were added to satisfy Mn:Fe:Li:P-0.5:0.5:1:1, a resulting mixture was ultrasonically dispersed in a deionized water, then transferred to a ball mill, and ball milled for a second time at 400 rpm for 5 hrs. A secondary ball milling product was dried at 60° C., ground, and screened by a 200-mesh sieve to obtain a second solid mixture.

In step S4, in the presence of a liquid carbon source, the second solid mixture was sintered at 700° C. for 10 hrs, and naturally cooled to room temperature to obtain a core-shell structured lithium manganese iron phosphate composite electrode material.

### Comparative Example 3

A composite cathode material is provided, which comprises a carbon core and an LFMP coating layer covering the carbon core.

The preparation method of the composite cathode material in this comparative example comprises the following steps:

In step S1, 200 g of lithium manganese iron phosphate was placed in a tubular furnace introduced with nitrogen, added with 2 g of glucose, and roasted at a temperature of 650° C. for 5 hrs.

In step S2, the obtained lithium manganese iron phosphate was prepared into a slurry with dispersed and uniform particles by sand milling, and then a lithium manganese iron phosphate slurry was sprayed on a surface of 2 g of a solid carbon source by a spray drying device.

In step S3, a resulting lithium manganese iron phosphate obtained in step S2 was placed in the tubular furnace introduced with nitrogen, added with 40 g of glucose and roasted at a temperature of 750° C. for 5 hrs.

In step S4, the sample obtained in step S3 was cooled, then crushed and screened to obtain nano lithium manganese iron phosphate having a uniform particle size.

### Comparative Example 4

A composite cathode material is provided, which comprises an LFP core and a LFMP coating layer covering the LFP core.

The preparation method of the composite cathode material in this comparative example comprises the following steps:

In step S1, 2 g of lithium iron phosphate and nitrogen was placed in a tubular furnace introduced with nitrogen, added with 0.1 g of glucose and roasted at a temperature of 650° C. for 5 hrs.

In step S2: the sample obtained in step 1 was cooled, then crushed and screen to obtain nano lithium iron phosphate having a uniform particle size.

In step S3, 200 g of lithium manganese iron phosphate was placed in a tubular furnace introduced with nitrogen, added with 2 g of glucose, and roasted at a temperature of 650° C. for 5 hrs.

In step S4, the obtained lithium manganese iron phosphate was prepared into a slurry with dispersed and uniform particles by sand milling, and then a lithium manganese iron phosphate slurry was sprayed on a surface of 2 g of a solid lithium iron phosphate by a spray drying device.

In step S5, the lithium manganese iron phosphate obtained in step S4 was placed in the tubular furnace introduced with nitrogen, added with 40 g of glucose and roasted at a temperature of 750° C. for 5 hrs.

In step S6, the sample obtained in step S5 was cooled, then crushed and screened to obtain nano lithium manganese iron phosphate having a uniform particle size.

### 2. Example of Lithium-Ion Battery:

The composite cathode materials provided by the above-mentioned Examples 1-4 and the cathode materials provided in the comparative examples were respectively assembled into cathodes and lithium-ion batteries according to the following methods:

Cathode: under the same conditions, a cathode material, a Super P—Li, and a PVDF were mixed according to a mass ratio of the cathode material: Super P—Li:PVDF mass ratio being 90:5:5. NMP was adopted as a solvent, and the mixing method was ball mill mixing or degassing mixer mixing. If a ball mill was used, the ball milling time was set to 30 min, and the speed frequency was set to 20 HZ. If a homogenizer degasser was used for mixing, the mixing was performed at a speed of 600 rpm for 30 seconds, followed with a speed of 2000 rpm for 15 mins. After homogenization-coating-drying-cutting operations, a cathode plate was prepared, and the cathode plate was baked in a vacuum oven at a temperature of 100° C. to remove a trace water. The cathode material is the cathode materials provided in the above-mentioned Examples 1-4 and Comparative Examples 1-3, respectively.
Anode: graphite;
Electrolyte: lithium hexafluorophosphate (Tianci conductive liquid);

Separator: PE separator;
Assembly of lithium-ion battery: Assemble the lithium-ion battery in a glove box filled with argon gas and having a water and oxygen content being less than 10 ppm.
   3. Related performance test of lithium-ion battery:

The electrochemical performance of each lithium-ion battery assembled in the above lithium-ion battery example was tested, and the test conditions were as follows:

1. a conductive agent SuperP-Li, a binder PVDF, an active material lithium manganese iron phosphate (LMFP), and a solvent NMP were added to the ball mill cup in a certain proportion and ball milled until the materials were dissolved and dispersed evenly, during which, an ambient temperature was controlled at 25±10° C.;

2. The prepared slurry was coated and dried to obtain an LMFP electrode plate, during which, the ambient temperature was controlled at 25±10° C.;

3. The electrode plate was cut into a circle and assembled into a button battery, during which, the ambient temperature was controlled at 25±10° C.;

4. The prepared battery was installed on a test stand for testing, during which, the test environment was kept at a constant temperature of 25±2° C.

The measured results are listed Table 1 below.

TABLE 1

| | | | 0.1 C | | |
|---|---|---|---|---|---|
| | | 0.1 C | specific | Compaction | |
| Experimental | Cycle | capacity | capacity | density | Resistivity |
| group | performance | mAh/g | wh/kg | g/cm³ | Ω · cm |
| Example 1 | Greater than | 156.2 | 585.6 | 2.453 | 1.3 |
| | 2000 cycles | | | | |
| Example 2 | Greater than | 154.6 | 579.4 | 2.464 | 1.8 |
| | 2000 cycles | | | | |
| Example 3 | Greater than | 154.3 | 578.9 | 2.458 | 2.8 |
| | 2000 cycles | | | | |
| Example 4 | Greater than | 156.4 | 576.9 | 2.468 | 0.5 |
| | 2000 cycles | | | | |
| Comparative | Greater than | 137.6 | 520.2 | 2.458 | 54.3 |
| Example 1 | 2000 cycles | | | | |
| Comparative | Greater than | 153.3 | 570.7 | 2.456 | 42.6 |
| Example 2 | 1500 cycles | | | | |
| Comparative | Greater than | 138.3 | 519.8 | 2.453 | 64.1 |
| Example 3 | 2000 cycles | | | | |
| Comparative | Greater than | 144.3 | 536.8 | 2.458 | 48.3 |
| Example 4 | 2000 cycles | | | | |

It can be seen from the examples and comparative examples in the above Table 1 that the present invention greatly shortens the lithium ion transmission distance, thus, the particles can be enlarged without affecting a cycle performance of the battery, and have the advantages of good cycle performance, high discharge efficiency, high compaction performance, good conductivity, and the like.

The above examples only express several implementation methods of the present application, and the description is relatively specific and detailed, but it cannot be construed as a limitation on the protection scope of the present patent application. It should be understood that for those skilled in the art, without departing from the concept of the present application, several modifications and improvements can be made, which all fall within the protection scope of the present patent application. Therefore, the protection scope of the present patent application shall be based on the attached claims.

1. A composite cathode material, characterized by comprising: a conductive core, and a cathode material coating layer covering the conductive core;
wherein
the composite cathode material further comprises a conductive skeleton; and
one end of the conductive skeleton is in contact with the conductive core, and an other end of the conductive skeleton at least extends into the cathode material coating layer.

2. The composite cathode material according to claim 1, wherein a mass ratio of the conductive core, the conductive skeleton, and the cathode material coating layer is 1:(1 to 3):(100 to 300); and/or
the composite cathode material further comprises a conductive coating layer, and the conductive coating layer is coated on an outer surface of the cathode material coating layer; and/or
the other end of the conductive skeleton extends to the outer surface of the cathode material coating layer.

3. The composite cathode material according to claim 2, wherein a thickness of the conductive coating layer is 2 nm to 20 nm; and/or
a conductive material contained in the conductive coating layer comprises at least one of a graphite, a carbon black, and/or an acetylene black; and/or
the other end of the conductive skeleton at least extends to an outer surface of the conductive coating layer.

4. The composite cathode material according to claim 1, wherein the conductive skeleton, after extending into the cathode material coating layer, is bent, or forms a network structure or a winding contact with the conductive skeleton.

5. The composite cathode material according to claim 1, wherein a particle size of the conductive core is smaller than 80 nm; and/or
a length of the conductive skeleton is 6 μm to 8 μm and/or
a thickness of the cathode material coating layer is 3 μm to 6 μm; and/or
a D50 of the composite cathode material is 3 μm to 6 μm.

6. The composite cathode material according to claim 1, wherein
the conductive skeleton is in a structure of a hollow tube; and/or
a material of the conductive skeleton comprises at least one of a carbon nanotube, a graphite flake, a conductive graphite, a carbon fiber, and a graphene conductive agent; and/or
a material of the conductive core comprises at least one of a cathode material and a carbon; and/or
a cathode material contained in the cathode material coating layer comprises at least one of a phosphate-based cathode material and lithium manganate.

7. The composite cathode material according to claim 6, wherein an inner diameter of the hollow tube is 2 nm to 20 nm;
in a case where the material of the conductive skeleton is at least one of the graphite flake, the conductive graphite, the carbon fiber, and the graphene conductive agent, a length or a width or a particle size of the conductive skeleton is 6 μm to 8 μm; and
in a case where the material of the conductive skeleton is the graphite flake or graphene, a thickness of the conductive skeleton is 2 nm to 40 nm.

8. The composite cathode material according to claim 6, wherein the carbon contained in the material of the conductive core comprises a sintered carbon; and
the cathode material contained in the material of the conductive core comprises at least one of LFP, lithium manganate, and/or lithium manganese phosphate.

9. The composite cathode material according to claim 6, wherein the conductive core is the carbon, the conductive skeleton is the carbon nanotube, and the cathode material is lithium manganese iron phosphate; and/or
a length of the hollow tube is 6 μm to 8 μm, and an inner diameter of the hollow tube is 2 nm to 20 nm.

10. A method for preparing a composite cathode material, characterized by comprising the following steps:
preparing a composite particle formed by a conductive skeleton and a conductive particle; wherein one end of the conductive skeleton is bonded to the conductive particle, and an other end of the conductive skeleton away from the conductive particle forms a free extension end; and
forming a cathode material coating layer covering the composite particle at a surface of the composite particle, wherein the free extension end of the conductive skeleton at least extends into the cathode material coating layer to form the composite cathode material.

11. The preparation method according to claim 10, wherein a method for preparing the composite particle formed by the conductive skeleton and the conductive particle comprises the following steps:
providing the conductive particle, performing modification treatment by a first functional group on the conductive particle to obtain a modified conductive particle;
providing the conductive skeleton, performing modification treatment by a second functional group on one end of the conductive skeleton to obtain a modified conductive skeleton; wherein the second functional group is a functional group capable of chemically reacting with the first functional group to form a chemical bond;
subjecting the modified conductive particle and the modified conductive skeleton to a first mixing treatment and a chemical reaction treatment, so that a modified end of the conductive skeleton is bonded to the conductive particle to obtain the composite particle;
and/or
the method of forming the cathode material coating layer covering the composite particle at the surface of the composite particle, comprises the following steps:
subjecting a cathode material or a cathode material precursor to a second mixing treatment with the composite particle, to enable the cathode material or the cathode material precursor to cover the surface of the composite particle, then performing sintering treatment;
and/or
after the step of forming the cathode material coating layer covering the composite particle at the surface of the composite particle, the method further comprising a step of forming a conductive coating layer covering the cathode material coating layer at a surface of the cathode material coating layer.

12. The preparation method according to claim 11, wherein the modified conductive particle and the modified conductive skeleton are subjected to the first mixing treatment according to a mass ratio of the conductive particle to the conductive skeleton of 1:(1 to 3); and/or
the conductive particle comprises at least one of a cathode material and a carbon, wherein, the carbon comprises a sintered carbon, and the cathode material comprises at least one of LFP, lithium manganate, and/or lithium manganese phosphate; and/or
the first functional group and the second functional group independently comprise at least one of a hydroxyl, an aldehyde group, a carboxyl, an amino, an ester group, and an anhydride.

13. The preparation method according to claim 11, wherein the cathode material or cathode material precursor and the composite particle are subjected to the second mixing treatment according to a mass ratio of the conductive skeleton to the cathode material of (1 to 3):(100 to 300); and/or
the sintering treatment is performed at a temperature of 600° C. to 700° C. for a duration of 5 hrs to 8 hrs.

14. A cathode plate, comprising a current collector and a cathode active layer bonded to a surface of the current collector, wherein
the cathode active layer comprises the composite cathode material according to claim 1.

15. A secondary battery, comprising a cathode plate and an anode plate, wherein the cathode plate is the cathode plate according to claim 14.

16. The composite cathode material according to claim 2, wherein the conductive skeleton, after extending into the cathode material coating layer, is bent, or forms a network structure or a winding contact with the conductive skeleton.

17. The composite cathode material according to claim 3, wherein the conductive skeleton, after extending into the cathode material coating layer, is bent, or forms a network structure or a winding contact with the conductive skeleton.

18. The composite cathode material according to claim 2, wherein
the conductive skeleton is in a structure of a hollow tube; and/or
a material of the conductive skeleton comprises at least one of a carbon nanotube, a graphite flake, a conductive graphite, a carbon fiber, and a graphene conductive agent; and/or
a material of the conductive core comprises at least one of a cathode material and a carbon; and/or
a cathode material contained in the cathode material coating layer comprises at least one of a phosphate-based cathode material and lithium manganate.

19. The composite cathode material according to claim 3, wherein
the conductive skeleton is in a structure of a hollow tube; and/or
a material of the conductive skeleton comprises at least one of a carbon nanotube, a graphite flake, a conductive graphite, a carbon fiber, and a graphene conductive agent; and/or
a material of the conductive core comprises at least one of a cathode material and a carbon; and/or
a cathode material contained in the cathode material coating layer comprises at least one of a phosphate-based cathode material and lithium manganate.

20. The composite cathode material according to claim 4, wherein
the conductive skeleton is in a structure of a hollow tube; and/or
a material of the conductive skeleton comprises at least one of a carbon nanotube, a graphite flake, a conductive graphite, a carbon fiber, and a graphene conductive agent; and/or
a material of the conductive core comprises at least one of a cathode material and a carbon; and/or
a cathode material contained in the cathode material coating layer comprises at least one of a phosphate-based cathode material and lithium manganate.
